(19) United States
(12) Patent Application Publication
(10) Pub. No.: US 2008/0126093 A1
(43) Pub. Date: May 29, 2008

(54) Method, Apparatus and Computer Program Product for Providing a Language Based Interactive Multimedia System

(75) Inventor: Sunil Sivadas, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/563,829

(22) Filed: Nov. 28, 2006

(51) Int. Cl. G10L 21/00

(52) U.S. Cl. 704/254; 704/E13.009

(57) ABSTRACT

An apparatus for providing a language based interactive multimedia system includes a selection element, a comparison element and a processing element. The selection element may be configured to select a phoneme graph based on a type of speech processing associated with an input sequence of phonemes. The comparison element may be configured to compare the input sequence of phonemes to the selected phoneme graph. The processing element may be in communication with the comparison element and configured to process the input sequence of phonemes based on the comparison.

### TECHNOLOGICAL FIELD

Embodiments of the present invention relate generally to speech processing technology and, more particularly, relate to a method, apparatus, and computer program product for providing an architecture for a language based interactive multimedia system.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, etc. The services may also be in the form of interactive applications in which the user may respond to a network device in order to perform a task, play a game or achieve a goal. The services may be provided from a network server or other network device, or even from the mobile terminal such as, for example, a mobile telephone, a mobile television, a mobile gaming system, etc.

In many applications, it is necessary for the user to receive audio information such as oral feedback or instructions from the network or mobile terminal or for the user to give oral instructions or feedback to the network or mobile terminal. Such applications may provide for a user interface that does not rely on substantial manual user activity. In other words, the user may interact with the application in a hands free or semi-hands free environment. An example of such an application may be paying a bill, ordering a program, requesting and receiving driving instructions, etc. Other applications may convert oral speech into text or perform some other function based on recognized speech, such as dictating SMS or email, etc. In order to support these and other applications, speech recognition applications, applications that produce speech from text, and other speech processing devices are becoming more common.

Speech recognition, which may be referred to as automatic speech recognition (ASR), may be conducted by numerous different types of applications. Current ASR systems are highly biased in their design towards improving the recognition of speech in English. The systems integrate high-level information about the language, such as pronunciation and lexicon, in the decoding stage to restrict the search space. However, most European and Asian languages are different from English in their morphological typology. Accordingly, English may not be the ideal language with which to research if results need to be generalized over other more compounded and/or highly inflected languages. For example, each other of the 20 official languages in the European Union exhibit a greater degree of compounding/inflection than English. The existing monolithic ASR architecture is not suitable for extending the technology to other languages. Even though some multilingual ASR systems have been developed, each language typically requires its own pronunciation modeling. Therefore, implementation of multilingual ASR systems in portable terminals is often restricted due to the limitations in the available memory size and processing power.

Meanwhile, devices that produce speech from text, such as text-to-speech (TTS) devices typically analyze text and perform phonetic and prosodic analysis to generate phonemes for output as synthetic speech relating the content of the original text. Other devices may take an input voice and convert the input into a different voice, which is known as voice conversion. In general terms, devices like those described above may be described as spoken language interfaces.

Although spoken language interfaces such as those described above are in use, there is currently no satisfying mechanism for providing integration of such devices within a single architecture. In this regard, proposals for combining ASR and TTS have been limited to providing TTS services only for words recognized by the ASR system. Accordingly, such proposals are limited in their versatility. Furthermore, language specificity is a common shortcoming of many such devices.

Accordingly, there may be need to develop a robust spoken language interface that overcomes the problems described above.

### BRIEF SUMMARY

A method, apparatus and computer program product are therefore provided for an architecture of a spoken language based interactive media system. According to exemplary embodiments of the present invention, a sequence of input phonemes from a speech processing device may be examined and processed according to the type of input in order to further process the input phonemes using a robust phoneme graph or lattice which is associated with the type of input speech. Thus, for example, both ASR and TTS inputs may be processed using a corresponding phoneme graph or lattice selected to provide an improved output for use in production of synthetic speech, low bit rate coded speech, voice conversion, voice to text conversion, information retrieval based on spoken input, etc. Additionally, embodiments of the present invention may be universally applicable to all spoken languages. As a result any of the uses described above may be improved due to a higher quality, more natural or accurate input. Additionally, it may not be necessary to have language specific modules thereby improving both the capability and efficiency of speech processing devices.

In one exemplary embodiment, a method of providing a language based multimedia system is provided. The method includes selecting a phoneme graph based on a type of speech processing associated with an input sequence of phonemes, comparing the input sequence of phonemes to the selected phoneme graph, and processing the input sequence of phonemes based on the comparison.

In another exemplary embodiment, a computer program product for providing a language based multimedia system is provided. The computer program product includes at least one computer-readable storage medium having computer-readable program code portions stored therein. The computer-readable program code portions include first, second and third executable portions. The first executable portion is for selecting a phoneme graph based on a type of speech processing associated with an input sequence of phonemes. The second executable portion is for comparing the input sequence of phonemes to the selected phoneme graph. The third executable portion is for processing the input sequence of phonemes based on the comparison.

In another exemplary embodiment, an apparatus for providing a language based multimedia system is provided. The apparatus includes a selection element, a comparison element and a processing element. The selection element may be configured to select a phoneme graph based on a type of speech processing associated with an input sequence of phonemes. The comparison element may be configured to compare the input sequence of phonemes to the selected phoneme graph. The processing element may be in communication with the comparison element and configured to process the input sequence of phonemes based on the comparison.

In another exemplary embodiment, an apparatus for providing a language based multimedia system is provided. The apparatus includes means for selecting a phoneme graph based on a type of speech processing associated with an input sequence of phonemes, means for comparing the input sequence of phonemes to the selected phoneme graph and means for processing the input sequence of phonemes based on the comparison.

Embodiments of the invention may provide a method, apparatus and computer program product for employment in systems where numerous types of speech processing are desired. As a result, for example, mobile terminals and other electronic devices may benefit from an ability to perform various types of speech processing via a single architecture which may be robust enough to offer speech processing for numerous languages, without the use of separate modules.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing a language based interactive multimedia system according to an exemplary embodiment of the present invention;

FIGS. 4A and 4B illustrate a schematic diagram of examples of processing a phoneme sequence according to an exemplary embodiment of the present invention; and

FIG. 5 is a block diagram according to an exemplary method for providing a language based interactive multimedia system according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

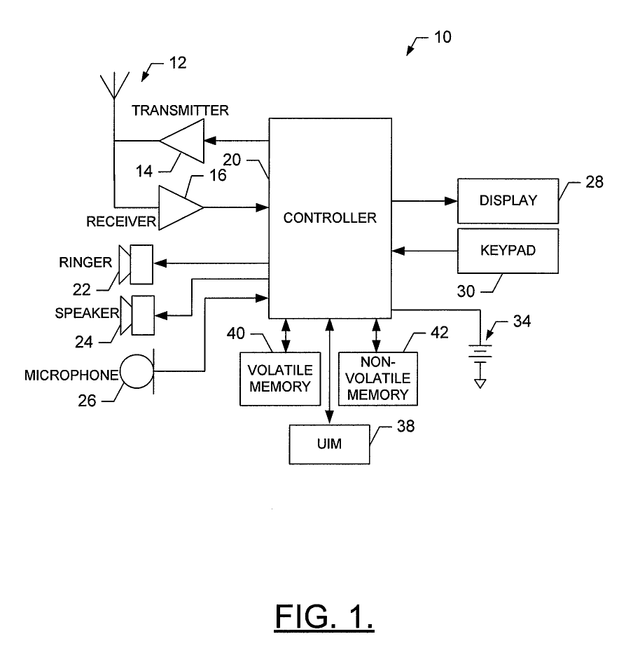

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

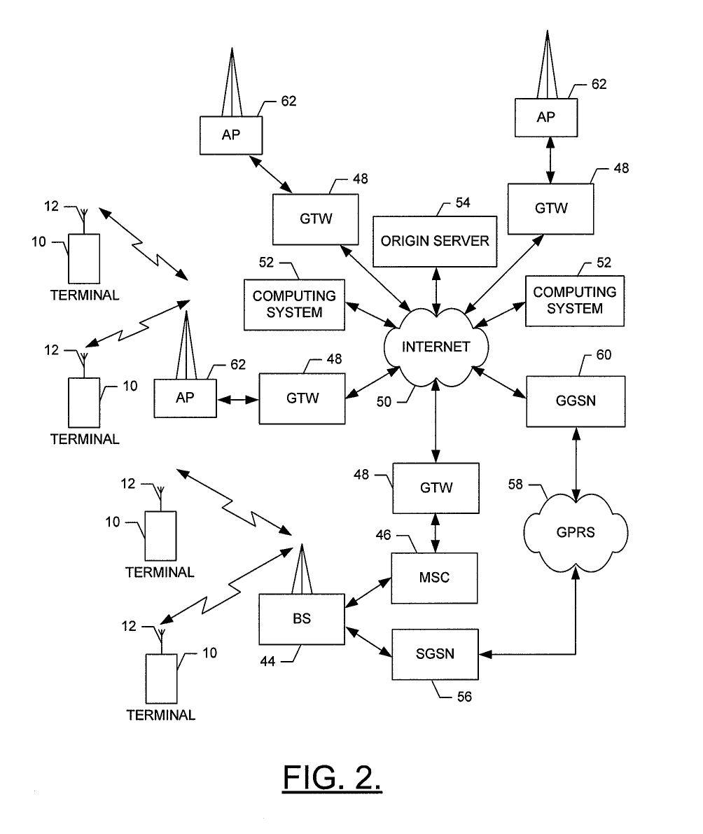

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

In an exemplary embodiment, data associated with a spoken language interface may be communicated over the system of FIG. 2 between a mobile terminal, which may be similar to the mobile terminal 10 of FIG. 1 and a network device of the system of FIG. 2, or between mobile terminals. As such, it should be understood that the system of FIG. 2 need not be employed for communication between the server and the mobile terminal, but rather FIG. 2 is merely provided for purposes of example. Furthermore, it should be understood that embodiments of the present invention may be resident on a communication device such as the mobile terminal 10, or may be resident on a network device or other device accessible to the communication device.

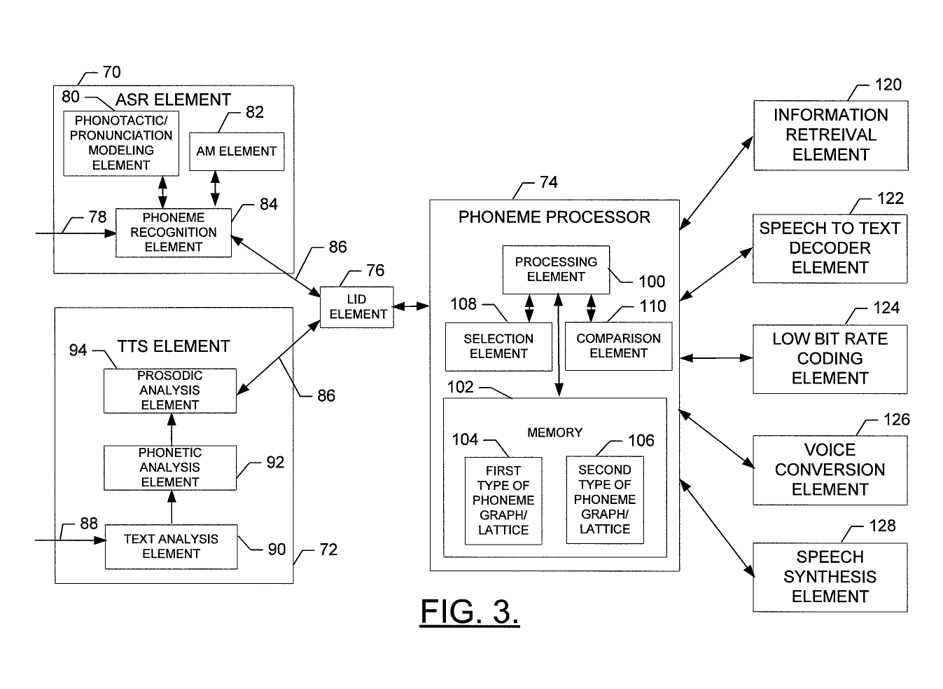

An exemplary embodiment of the invention will now be described with reference to FIG. 3, in which certain elements of a system for providing an architecture of a language based interactive multimedia system are displayed. The system of FIG. 3 will be described, for purposes of example, in connection with the mobile terminal 10 of FIG. 1. However, it should be noted that the system of FIG. 3, may also be employed in connection with a variety of other devices, both mobile and fixed, and therefore, embodiments of the present invention should not be limited to application on devices such as the mobile terminal 10 of FIG. 1. It should also be noted, that while FIG. 3 illustrates one example of a configuration of a system for providing intelligent synchronization, numerous other configurations may also be used to implement embodiments of the present invention.

Referring now to FIG. 3, a system 68 for providing an architecture of a language based interactive multimedia system is provided. The system 68 includes a first type of speech processing element such as an ASR element 70 and a second type of speech processing element such as a TTS element 72 in communication with a phoneme processor 74. As shown in FIG. 3, in one embodiment, the phoneme processor 74 may be in communication with the ASR element 70 and the TTS element 72 via a language identification LID element 76.

The ASR element 70 may be any device or means embodied in either hardware, software, or a combination of hardware and software capable of producing a sequence of phonemes based on an input speech signal 78. FIG. 3 illustrates one exemplary structure of the ASR element 70, but others are also possible. In this regard, the ASR element 70 may include two source units including an on-line phonotactic/pronunciation modeling element 80 (e.g., a Text-to-Phoneme (TTP) mapping element) and acoustic model (AM) element 82, and a phoneme recognition element 84. The phonotactic/pronunciation modeling element 80 may include phoneme definitions and pronunciation models for at least one language stored in a pronunciation dictionary. As such, words may be stored in a form of a sequence of character units (text sequence) and in a form of a sequence of phoneme units (phoneme sequence). The sequence of phoneme units represents the pronunciation of the sequence of character units. So-called pseudophoneme units can also be used when a letter maps to more than one phoneme. The AM element 82 may include an acoustic pronunciation model for each phoneme or phoneme unit. The phoneme recognition element 84 may be configured to break the input speech signal into the input sequence of phonemes 86 based on data provided by the AM element 82 and the phonotactic/pronunciation modeling element 80.

The representation of the phoneme units may be dependent on the phoneme notation system used. Several different phoneme notation systems can be used, e.g. SAMPA and IPA. SAMPA (Speech Assessment Methods Phonetic Alphabet) is a machine-readable phonetic alphabet. The International Phonetic Association provides a notational standard, the International Phonetic Alphabet (IPA), for the phonetic representation of numerous languages.

The ASR element 70 may include a single-language ASR capability or a multilingual ASR capability. If the ASR element 70 includes a multilingual capability, the ASR element 70 may include separate TTP models for each language. Furthermore, as an alternative to the illustrated embodiment of FIG. 3, a multilingual ASR element may include an automatic language identification (LID) element, which finds the language identity of a spoken word based on the language identification model. Accordingly, when a speech signal is input into a multilingual ASR element, an estimate of the used language may first be made. After the language identity is known, an appropriate on-line TTP modeling scheme may be applied to find a matching phoneme transcription for the vocabulary item. Finally, the recognition model for each vocabulary item may be constructed as a concatenation of multilingual acoustic models specified by the phoneme transcription. Using these basic modules the ASR element 70 can, in principle, automatically cope with multilingual vocabulary items without any assistance from the user.

However, as shown in FIG. 3, the LID element 76 may be embodied as a separate element disposed between the ASR element 70 and the phoneme processor 74. Additionally, the output of the TTS element 72 may also be input into the LID element 76. It should also be understood that the LID element 76 could be a part of the phoneme processor 74 or the LID element 76 may be disposed to receive an output of the phoneme processor. In any case, the LID element 76 may be any device or means embodied in either hardware, software, or a combination of hardware and software capable of receiving an input sequence of phonemes 86 and determining the language associated with the input sequence of phonemes 86. In an exemplary embodiment, when the input sequence of phonemes 86 is received from the TTS element 72, the LID element 84 may be configured to automatically determine the language associated with the input sequence of phonemes 86. However, when the input sequence of phonemes 86 is received from the ASR element 70, the LID element 84 may incorporate region information regarding a region in which the system 68 is sold or otherwise expected to operate. As such, the LID element 84 may incorporate information about languages which are likely to be encountered based on the region information. Once the LID element 76 has determined the language associated with the input sequence of phonemes 86, an indication of the determined language may be communicated to the phoneme processor 74.

The TTS element 72 may be based on similar elements to those of the ASR element 70, although such elements and related algorithms may have been developed from a different perspective. In this regard, the ASR element 70 outputs the input sequence of phonemes 86 based on the input speech signal 78, while the TTS element 72 outputs the input sequence of phonemes 86 based on an input text 88. The TTS element 72 may be any device or means embodied in either hardware, software, or a combination of hardware and software capable of receiving the input text 88 and producing the input sequence of phonemes 86 based on the input text 88, for example, via processes such as text analysis, phonetic analysis and prosodic analysis. As such, the TTS element 72 may include a text analysis element 90, a phonetic analysis element 92 and a prosodic analysis element 94 for performing the corresponding analyses as described below.

In this regard, the TTS element 72 may initially receive the input text 88 and the text analysis element 90 may, for example, convert non-written-out expressions, such as numbers and abbreviations, into a corresponding written-out word equivalent. Subsequently, in a text pre-processing phase, each word may be fed into the phonetic analysis element 92 in which phonetic transcriptions are assigned to each word. The phonetic analysis element 92 may employ a text-to-phoneme (TTP) conversion similar to that described above with respect to the ASR element 70. Finally, the prosodic analysis element 92 may divide the text and mark segments of the text into various prosodic units, like phrases, clauses, and sentences. The combination of phonetic transcriptions and prosody information make up a symbolic linguistic representation output of the TTS element 72, which may be output as the input sequence of phonemes 86. The input sequence of phonemes 86 may be communicated to the phoneme processor 74 either directly or via the LID element 76. If a playback of the text is desired, the symbolic linguistic representation may be input into a synthesizer, which outputs the synthesized speech waveform, i.e. the actual sound output following processing at the phoneme processor 74.

The phoneme processor 74 may be any device or means embodied in either hardware, software, or a combination of hardware and software capable of receiving the input sequence of phonemes 86, examining the input sequence of phonemes 86 and comparing the input sequence of phonemes 86 to a selected phoneme graph based on whether the input sequence of phonemes is received from either a first or second type of speech processing element. Accordingly, the phoneme processor 74 may be configured to process the input sequence of phonemes 86 to improve a quality measure associated with the input sequence of phonemes 86 so that an output of the phoneme processor 74 may be used to drive any of numerous output devices which may be utilized in connection with the system 68. In an exemplary embodiment, the quality measure may be a probability measure, a distortion measure, or any other quality metric that may be associated with processed speech in assessing the accuracy and/or naturalness of the processed speech. In various exemplary embodiments, the quality measure could be improved by optimizing, maximizing or otherwise increasing a probability that a given input phoneme sequence constructed by the system 68 is correct if the input sequence of phonemes 86 is received from an ASR element or optimizing, minimizing or otherwise reducing a distortion measure associated with the input sequence of phonemes 86 if the input sequence of phonemes 86 is received from a TTS element. The distortion measure may be made in relation to target speech or other training data.

Output devices which could be driven with the output of the phoneme processor 74 may be dependent upon the type of input provided. For example, if the ASR element 70 provides the input sequence of phonemes 86, output devices may include an information retrieval element 120, a speech to text decoder element 122, a low bit rate coding element 124, a voice conversion element 126, etc. Meanwhile, if the TTS element 72 provides the input sequence of phonemes 86, output devices may include the low bit rate coding element 124, a speech synthesis element 128, the information retrieval element 120, etc.

The speech to text decoder element 122 may be any device or means configured to convert input speech into an output of text corresponding to the input speech. By separating higher-level information in the ASR element 70, such as pronunciation and lexicon, from the decoding stage, the system 68 provides a way to handle words that do not necessarily appear in a vocabulary listing associated with the system 68. The phoneme graph/lattice architecture of the phoneme processor 74 may include information useful for subsequent phoneme-word conversion. The speech synthesis element 128 may include information for generating enhanced speech quality by utilizing both linguistic and prosodic information from the phoneme graph/lattice architecture of the phoneme processor 74. The low bit rate coding element 124 may be utilized for speech coding with bit rates as low as or even below 500 bps and may include a coder that acts as a speech recognition system and a decoder that works as a speech synthesizer. The coder may implement recognition of acoustic segments in an analysis phase and speech synthesis from a set of segment indices in the decoder. The coder may generate a symbolic transcription of the speech signal typically from a dictionary of linguistic units (e.g. phonemes, subword units). Accordingly, the presented data structure may offer a wide source of linguistic units to be used in the generation of the symbolic transcription of the input speech signal 80. Once the phonemes are decoded, their identity can be transmitted along with the prosodic information required for synthesis in the decoder at the very low bit rate. The voice conversion element 126 may enable conversion of the voice of a source speaker to the voice of a target speaker. The presented data structure can be utilized also in voice conversion such that a statistical model is first created for the source speaker, based on target voice characteristics and the various prosodic information stored in the data structure. Parameters of the statistical model may then be subjected to a parameter adaptation process, which may convert the parameters such that the voice of the source speaker is converted to the voice of a target speaker. The information retrieval element 120 may include a database of spoken documents, wherein each spoken document is structured according to a presented data structure (e.g., words are divided into subword units, such as phonemes). When a user wants to search certain data from the database of spoken documents, it may be advantageous to use a sequence of subword units as the search pattern, rather than whole words. Thus, the vocabulary of the phoneme processor 74 may be unrestricted and it may be efficient to pre-compute the phoneme graph/lattice.

The phoneme processor 74 may include or otherwise be controlled by a processing element 100. The phoneme processor 74 may also include or otherwise be in communication with a memory element 102 storing a first type of phoneme graph/lattice 104 and a second type of phoneme graph/lattice 106. The phoneme processor 74 may also include a selection element 108 and a comparison element 10. The selection element 108 and the comparison element 110 may each be any device or means embodied in either hardware, software, or a combination of hardware and software capable of performing the corresponding functions of the selection element 108 and the comparison element 110, respectively, as described in greater detail below. In this regard, the selection element 108 may be configured to examine the input sequence of phonemes 86 to determine whether the input sequence of phonemes 86 corresponds to the first type of speech processing element (e.g., the ASR element 70) or the second type of speech processing element (e.g., the TTS element 72). The selection element 108 may also be configured to select one of the first type of phoneme graph/lattice 104 or the second type of phoneme graph/lattice 106 based on the origin of the input sequence of phonemes 86 (i.e., whether the source of the input sequence of phonemes 86 was the ASR element 70 or the TTS element 72). Meanwhile, the comparison element 110 may be configured to compare the input sequence of phonemes 86 to the selected phoneme graph. In other words, the comparison element 110 may be configured to compare the input sequence of phonemes 86 to a corresponding one of the first type of phoneme graph/lattice 104 (e.g., an ASR phoneme graph) or the second type of phoneme graph/lattice 106 (e.g., a TTS phoneme graph) based on the determined type of speech processing element associated with the input sequence of phonemes 86.

In an exemplary embodiment, the phoneme processor 74 may be embodied in software in the form of an executable application, which may operate under the control of the processing element 100 (e.g., the controller 20 of FIG. 1) which may execute instructions associated with the executable application which are stored at the memory 102 or otherwise may be accessible to the processing element 100. A processing element as described herein may be embodied in many ways. For example, the processing element 100 may be embodied as a processor, a coprocessor, a controller or various other processing means or devices including integrated circuits such as, for example, an ASIC (application specific integrated circuit). The memory element 102 may be, for example, the volatile memory 40 or the non-volatile memory 42 of the mobile terminal 10 or may be another memory device accessible by the processing element 100 of the phoneme processor 74.

The first type of phoneme graph/lattice 104 may be, for example, a graph or lattice of information about the most likely sequence of phonemes based on statistical probability. In this regard, the first type of phoneme graph/lattice 104 may be configured to provide a probabilistic based comparison between the input phoneme sequence and the most likely phoneme to follow in combination with each current phoneme. By comparing the input sequence of phonemes 86 with the first type of phoneme graph/lattice 104, the language processor 74 may optimize or otherwise increase a probability that the output of the language processor produces a processed speech having a natural and accurate correlation to the input speech signal 78.

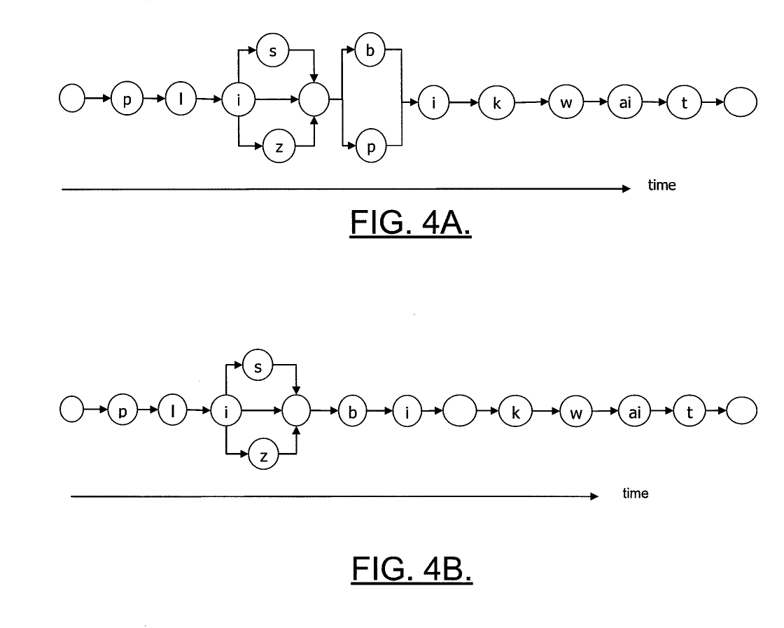

FIGS. 4A and 4B illustrate exemplary embodiments of processing a phoneme sequence for the utterance “please be quite”, which could be part of a sentence or larger phrase. In this regard, it should be understood that each circle of FIGS. 4A and 4B represents a possible phoneme and each arrow between various circles has an associated weight which is determined based on a probability that a subsequent phoneme may follow a current phoneme. As such, the phoneme processor 74 may process the input sequence of phonemes 86 by determining a path through the graph which yields a highest probability outcome based on the weights between each intermediate phoneme. Thus, an output of the phoneme processor 74 may be a modified input sequence of phonemes, which is modified to maximize or otherwise improve the probability measure associated with the modified input sequence of phonemes. FIG. 4A shows an embodiment in which a phoneme lattice is utilized as an output of a speech recognition system. As can be seen from FIG. 4A, depending on the likelihood of each corresponding phoneme sequence, the utterance can be converted to text as, for example, “Please pick white”, “Please be quite”, or “Plea beak white”. FIG. 4B shows an embodiment in which a phoneme lattice is utilized as an input to a speech synthesis system. In the case of speech synthesis, the phoneme lattice may be formed at the output of the text processing module after prosodic analysis. Links in the lattice include weights related to the naturalness of the speech output. The phonemes used for synthesis may be chosen depending on the path of the minimum distortion (i.e., maximum naturalness). It should be noted that FIGS. 4A and 4B are just exemplary and thus, many other phoneme options other than those illustrated in FIGS. 4A and 4B are also possible. FIGS. 4A and 4B merely show a few of such options in order to provide a simple example for use in describing an exemplary embodiment.

The second type of phoneme graph/lattice 106 may be, for example, a graph or lattice of information related to data gathered offline such as training data which may be used for comparison with the input sequence of phonemes 86 to provide an improved quality (e.g., more natural or accurate) output from the phoneme processor 74. In this regard, the second type of phoneme graph/lattice 106 may be configured to provide a distortion measure based comparison between the input phoneme sequence and information related to, for example, prosody, duration (e.g., start and end times), speaker characteristics, etc. Thus, for example, target voice characteristics (e.g., data associated with the synthetic speech target speaker), subword units, and various prosodic information such as timing and accent of speech may be utilized as metadata used to process the input sequence of phonemes 86 by reducing a distortion measure or some other quality indicia. By comparing the input sequence of phonemes 86 with the second type of phoneme graph/lattice 106, the language processor 74 may optimize or otherwise reduce a distortion measure exhibited by the output of the language processor 74 in producing a processed speech having a natural and accurate correlation to the input text 88.

In an exemplary embodiment, the processing element 100 may receive the indication of the language associated with the input sequence of phonemes 86. In response to the indication, the processing element 100 may be configured to select a corresponding one among language specific first or second types of phoneme graph/lattices. However, in an exemplary embodiment, the language associated with the input sequence of phonemes 86 may simply be utilized as metadata used in connection with either the first type of phoneme graph/lattice 104 or the second type of phoneme graph/lattice 106. In other words, in one exemplary embodiment, the first type of phoneme graph/lattice 104 and/or the second type of phoneme graph/lattice 106 may be embodied as a single graph having information associated with a plurality of languages in which metadata identifying the language may be used as a factor in processing the input sequence of phonemes 86. Thus, the first type of phoneme graph/lattice 104 and/or the second type of phoneme graph/lattice 106 may be multilingual phoneme graphs thereby extending applicability of embodiments of the present invention beyond the utilization of multiple language modules to a single consolidated architecture.

Embodiments of the present invention may be useful for portable multimedia devices, since the elements of the system 68 may be designed in a memory efficient manner. In this regard, since different types of speech processing or spoken language interfaces may be integrated into a single architecture configured to process a sequence of phonemes based on the type of speech processing or spoken language interface providing the input, memory space may be minimized. Additionally, the integration of prominent spoken language interface technologies, such as ASR and the TTS into a single framework may facilitate efficient design and extension of design to different languages. Accordingly, interactive multimedia applications, such as interactive mobile games and spoken dialogue systems may be enhanced. For example, a player may be enabled to use his/her voice to control the game by utilizing the ASR element 70 for interpreting the commands. The player may also be enabled to program characters in the game to speak in the voice selected by the player, for example, by utilizing speech synthesis. Additionally or alternatively, the system 68 can transmit the player's voice at a low bit rate to another terminal, where another player can manipulate the player's voice by conversion of the player's voice to a target voice using speech coding and/or voice conversion.

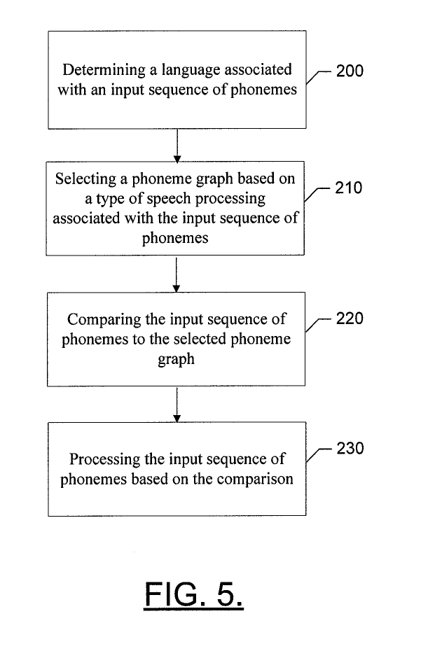

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal and executed by a built-in processor in mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing a language based interactive multimedia system may include examining an input sequence of phonemes in order to select a phoneme graph based on a type of speech processing associated with the input sequence of phonemes at operation 210. In an exemplary embodiment, operation 210 may include selecting one of a first phoneme graph corresponding to the input sequence of phonemes being received from an automatic speech recognition element or a second phoneme graph corresponding to the input sequence of phonemes being received from a text-to-speech element. The input sequence of phonemes may be compared to the selected phoneme graph at operation 220. At operation 230, the input sequence of phonemes may be processed based on the comparison. In an exemplary embodiment, operation 230 may include modifying the input sequence of phonemes based on the selected phoneme graph to improve a quality measure of the modified input sequence of phonemes. The quality measure may be improved by, for example, increasing a probability measure or decreasing a distortion measure associated with the modified input sequence of phonemes. In an exemplary embodiment, the method may include an optional initial operation 200 of determining a language associated with the input sequence of phonemes. The determined language may be used to select a corresponding phoneme graph, however, the phoneme graph may alternatively be applicable to a plurality of different languages.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
selecting a phoneme graph based on a type of speech processing associated with an input sequence of phonemes;
comparing the input sequence of phonemes to the selected phoneme graph; and
processing the input sequence of phonemes based on the comparison.

2. A method according to claim 1, wherein selecting the phoneme graph comprises selecting one of a first phoneme graph corresponding to the input sequence of phonemes being received from an automatic speech recognition element or a second phoneme graph corresponding to the input sequence of phonemes being received from a text-to-speech element.

3. A method according to claim 2, wherein selecting the phoneme graph further comprises selecting the second phoneme graph including metadata related to prosody information, duration, and speaker characteristics.

4. A method according to claim 3, further comprising determining a language associated with the input sequence of phonemes.

5. A method according to claim 4, wherein selecting the phoneme graph further comprises selecting a phoneme graph corresponding to the determined language.

6. A method according to claim 1, wherein selecting the phoneme graph further comprises selecting a single phoneme graph that corresponds to a plurality of languages.

7. A method according to claim 1, wherein processing the input sequence of phonemes comprises modifying the input sequence of phonemes based on the selected phoneme graph to improve a quality measure of the modified input sequence of phonemes.

8. A method according to claim 7, wherein processing the input sequence of phonemes further comprises modifying the input sequence of phonemes based on the selected phoneme graph to increase a probability measure of the modified input sequence of phonemes.

9. A method according to claim 7, wherein processing the input sequence of phonemes further comprises modifying the input sequence of phonemes based on the selected phoneme graph to decrease a distortion measure of the modified input sequence of phonemes.

10. A computer program product comprising at least one computer-readable storage medium having computer-readable program code portions stored therein, the computer-readable program code portions comprising:
a first executable portion for selecting a phoneme graph based on a type of speech processing associated with an input sequence of phonemes;
a second executable portion for comparing the input sequence of phonemes to the selected phoneme graph; and
a third executable portion for processing the input sequence of phonemes based on the comparison.

11. A computer program product according to claim 10, wherein the first executable portion includes instructions for selecting one of a first phoneme graph corresponding to the input sequence of phonemes being received from an automatic speech recognition element or a second phoneme graph corresponding to the input sequence of phonemes being received from a text-to-speech element.

12. A computer program product according to claim 11, wherein the first executable portion includes instructions for selecting the second phoneme graph including metadata related to prosody information, duration, and speaker characteristics.

13. A computer program product according to claim 12, further comprising a fourth executable portion for determining a language associated with the input sequence of phonemes.

14. A computer program product according to claim 13, wherein the first executable portion includes instructions for selecting a phoneme graph corresponding to the determined language.

15. A computer program product according to claim 10, wherein the first executable portion includes instructions for selecting a single phoneme graph that corresponds to a plurality of languages.

16. A computer program product according to claim 10, wherein the third executable portion includes instructions for modifying the input sequence of phonemes based on the selected phoneme graph to improve a quality measure of the modified input sequence of phonemes.

17. A computer program product according to claim 16, wherein the third executable portion includes instructions for modifying the input sequence of phonemes based on the selected phoneme graph to increase a probability measure of the modified input sequence of phonemes.

18. A computer program product according to claim 16, wherein the third executable portion includes instructions for modifying the input sequence of phonemes based on the selected phoneme graph to decrease a distortion measure of the modified input sequence of phonemes.

19. An apparatus comprising:
a selection element configured to select a phoneme graph based on a type of speech processing associated with an input sequence of phonemes;
a comparison element configured to compare the input sequence of phonemes to the selected phoneme graph; and
a processing element in communication with the comparison element and configured to process the input sequence of phonemes based on the comparison.

20. An apparatus according to claim 19, wherein the selection element is further configured to select one of a first phoneme graph corresponding to the input sequence of phonemes being received from an automatic speech recognition element or a second phoneme graph corresponding to the input sequence of phonemes being received from a text-to-speech element.

21. An apparatus according to claim 20, wherein the selection element is further configured to select the second phoneme graph including metadata related to prosody information, duration, and speaker characteristics.

22. An apparatus according to claim 21, further comprising a language identification element for determining a language associated with the input sequence of phonemes.

23. An apparatus according to claim 22, wherein the selection element is further configured to select a phoneme graph corresponding to the determined language.

24. An apparatus according to claim 19, wherein the selection element is further configured to select a single phoneme graph that corresponds to a plurality of languages.

25. An apparatus according to claim 19, wherein the processing element is further configured to modify the input sequence of phonemes based on the selected phoneme graph to improve a quality measure of the modified input sequence of phonemes.

26. An apparatus according to claim 25, wherein the processing element is further configured to modify the input sequence of phonemes based on the selected phoneme graph to increase a probability measure of the modified input sequence of phonemes.

27. An apparatus according to claim 25, wherein the processing element is further configured to modify the input sequence of phonemes based on the selected phoneme graph to decrease a distortion measure of the modified input sequence of phonemes.

28. An apparatus according to claim 19, wherein the apparatus is embodied as a mobile terminal.

29. An apparatus comprising:
means for selecting a phoneme graph based on a type of speech processing associated with an input sequence of phonemes;
means for comparing the input sequence of phonemes to the selected phoneme graph; and
means for processing the input sequence of phonemes based on the comparison.

30. An apparatus according to claim 29, wherein the means for selecting the phoneme graph further comprises means for selecting one of a first phoneme graph corresponding to the input sequence of phonemes being received from an automatic speech recognition element or a second phoneme graph corresponding to the input sequence of phonemes being received from a text-to-speech element.
